(19) United States
(12) Patent Application Publication
(10) Pub. No.: US 2018/0063318 A1
(43) Pub. Date: Mar. 1, 2018

(54) AUTOMOBILE SAFETY SYSTEM FOR A DRIVERS MOBILE DEVICE

(71) Applicant: SANTHOSH MURALIDHARAN, Nilgiris (IN)

(72) Inventor: SANTHOSH MURALIDHARAN, Nilgiris (IN)

(21) Appl. No.: 15/632,414

(22) Filed: Jun. 26, 2017

Related U.S. Application Data
(63) Continuation-in-part of application No. 15/375,189, filed on Dec. 12, 2016.

(30) Foreign Application Priority Data
Aug. 23, 2016 (IN) 201641028678
Mar. 15, 2017 (IN) 201743008874

(51) Int. Cl. H04M 1/725; H04N 5/247; G06K 9/00

(52) U.S. Cl. CPC H04M 1/72577; G06K 9/00798; G06K 9/00838; H04N 5/247

(57) ABSTRACT

A system for a safety application for an automobile is provided. The automobile safety system (102) is present in a driver's mobile device (104) and is configured to receive inputs from the driver to initiate a feature in the driver's mobile device (104). The automobile safety system (102) determines whether the driver is driving during safe duration or unsafe duration based on inputs. The automobile safety system (102) also determines whether the feature requested by the driver belongs to a group of permitted features. Further, the automobile safety system (102) prevents the feature's initiation if the feature doesn't belong to the group of permitted features. Alternatively, automobile safety system (102) initiates the feature if the input to initiate was received in safe duration and the feature belongs to the group of permitted features. Subsequently, automobile safety system (102) doesn't initiate the features if the input is received in unsafe duration.

### BACKGROUND

### Field of Invention

The subject matter in general relates to automobile safety systems. More particularly, but not exclusively, the subject matter relates to automobile safety systems communicating with a driver's mobile device.

### Discussion of Related Art

Electronic communication devices such as mobile phones, tablets and laptops ensure that people do not miss out on any important calls, messages, e-mails, and other reminders, among others. Such devices allow us to receive multiple notifications throughout the day. However, they tend to cause disturbances during certain actions that require increased focus and attention, such as driving. Several drivers face distractions while driving due to notifications from their mobile phones. Such distractions can result in accidents, collisions and potential injuries. Further, these distractions can cause harm to the driver as well as pedestrians, automobiles and other objects on the road.

Conventional systems have attempted to decrease distraction from mobile phones by disabling some of the functionality when the driver is driving their automobile. However, the drawback here is that the driver will remain uninformed in case any important notifications are received. Other conventional systems relay notifications to the driver. However, there are no options to choose when the driver should receive such notifications.

Conventional systems do not address these issues. Thus, conventional systems result in risks to the safety of the driver and others on the road. Additionally, conventional systems do not take any distractions into account while relaying notifications to the driver and hence, cause inconvenience to the driver. Further, with the current increase in the number of drivers using mobile phones and other electronic devices while driving, it is of prime importance to have improved systems solving these problems.

In light of the foregoing discussion, there is a need for an improved automobile safety system that can reduce the distraction caused by usage of smartphones, and also alert a driver who is distracted or drowsy when needed.

### SUMMARY

In an embodiment, an automobile safety system for an automobile is provided. The automobile safety system is present in a driver's mobile device and is configured to receive one or more inputs to initiate a feature in the driver's mobile device. The automobile safety system determines whether the driver is driving an automobile during a safe duration or an unsafe duration. The automobile safety system also determines whether the requested feature belongs to a group of one or more permitted features. Further, the automobile safety system prevents the initiation of the feature in case the feature does not belong to the group of one or more permitted features. Alternatively, the automobile safety system initiates the feature in case the input to initiate was received in the safe duration and the feature belongs to the group of one or more permitted features. Subsequently, the automobile safety system refrains from initiating the feature in case the input to initiate is received in the unsafe duration.

In an embodiment, the automobile safety system is configured to receive and interpret one or more inputs corresponding to the driver, wherein the inputs are in the form of a voice input, gesture input, image input or video input.

In an embodiment, the automobile safety system is configured to prevent one or more notification alerts regarding an event in case the event occurs during the unsafe duration. Further, the automobile safety system alerts and notifies the driver in the safe duration regarding the event that occurred during the unsafe duration.

In an embodiment, the automobile safety system is configured to determine whether the driver wants to initiate one or more permitted features during the safe duration, wherein the one or more permitted features are in response to the occurred event. Further, the automobile safety system receives and uses the driver's inputs in case the driver wants to initiate the permitted features.

In an embodiment, the automobile safety system is configured to receive one or more inputs related to the attentiveness of the driver and one or more distractions. Further, the automobile safety system generates one or more periodic alerts to keep the driver focussed while driving in case the driver is using a permitted feature in the safe duration. Additionally, the automobile safety system generates one or more alerts in case the automobile safety system determines that the driver is in unsafe duration based on the one or more inputs.

In an embodiment, the automobile safety system is configured to determine whether the unsafe duration comprises an emergency. The automobile safety system terminates one or more ongoing permitted features on the driver's mobile device and receives input from the driver to initiate one or more of the one or more features on the driver's mobile device in case of an emergency.

In an embodiment, the automobile safety system is configured to generate an alert of a first intensity level in case the driver is using a permitted feature in the safe duration. Further, the automobile safety system generates an alert of a second intensity level in case the driver is using a permitted feature in the unsafe duration. Subsequently, the automobile safety system generates an alert of a third intensity level in case the driver is using a permitted feature in the emergency. The third intensity level is greater compared to the second intensity level and the second intensity level is greater compared to the first intensity level.

In an embodiment, the automobile safety system is configured to list one or more permitted features belonging to the group of one or more permitted features in a priority list, wherein a permitted feature having higher priority is initiated before a permitted feature with lower priority.

In an embodiment, the automobile safety system is configured to interpret one or more pre-determined inputs of the driver to allow the initiation of at least one feature in a group of one or more features on the driver's mobile device in the safe duration and the unsafe duration.

In an embodiment, the group of one or more features comprise one or more features that are restricted from initiation by the driver prior to the interpretation of the one or more pre-determined inputs of the driver.

In an embodiment, the group of one or more features are configurable to be pre-determined by the driver, when the driver wants to restrict the co-passenger from accessing one or more features.

In an embodiment, an automobile safety system for an automobile is provided. The automobile safety system comprises a first camera directed to have a field of view to capture video of a driver of the automobile and a second camera directed to have a field of view to capture video of a road ahead of the automobile. The automobile safety system further includes a processing module configured to communicate with a driver's mobile device. The processing module receives one or more notifications from the driver's mobile device. The processing module further receives one or more inputs from the driver to initiate one or more features on the driver's mobile device. Subsequently, the processing module determines a safe duration and an unsafe duration based on inputs from the first camera and the second camera, and enable initiation of one or more permitted features on the driver's mobile device in case the safe duration has been detected. Subsequently, the processing module prevents the initiation of the permitted features on the driver's mobile device in case the unsafe duration is detected. Subsequently, the processing module alerts the driver during the unsafe duration regarding possible distractions; and alerts the driver during the safe duration regarding one or more among an alert to keep the driver focused and one or more received notifications.

### BRIEF DESCRIPTION OF DIAGRAMS

This disclosure is illustrated by way of example and not limitation in the accompanying figures. Elements illustrated in the figures are not necessarily drawn to scale, in which like references indicate similar elements and in which:

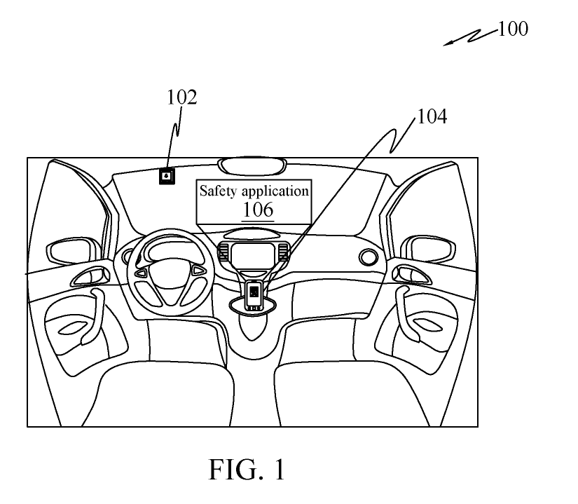

FIG. 1 illustrates a system 100 including an automobile safety system 102 provided in a driver's mobile device 104, in accordance with an embodiment;

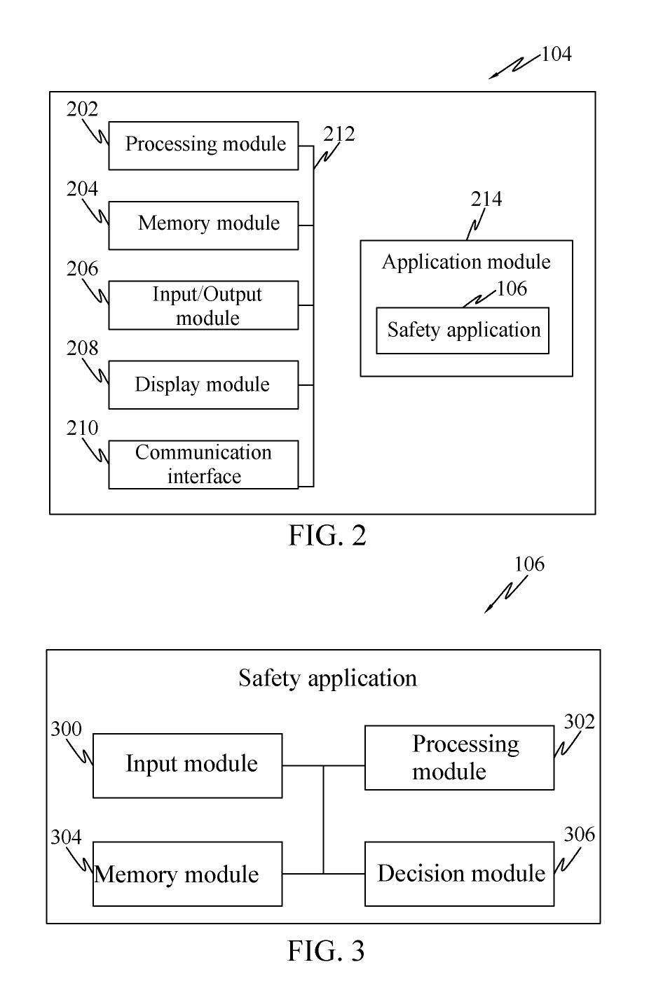

FIG. 2 illustrates an exemplary block diagram of a driver's mobile device 104 of the system 100, in accordance with an embodiment;

FIG. 3 illustrates an exemplary block diagram of the safety application 106 of the system 100, in accordance with an embodiment;

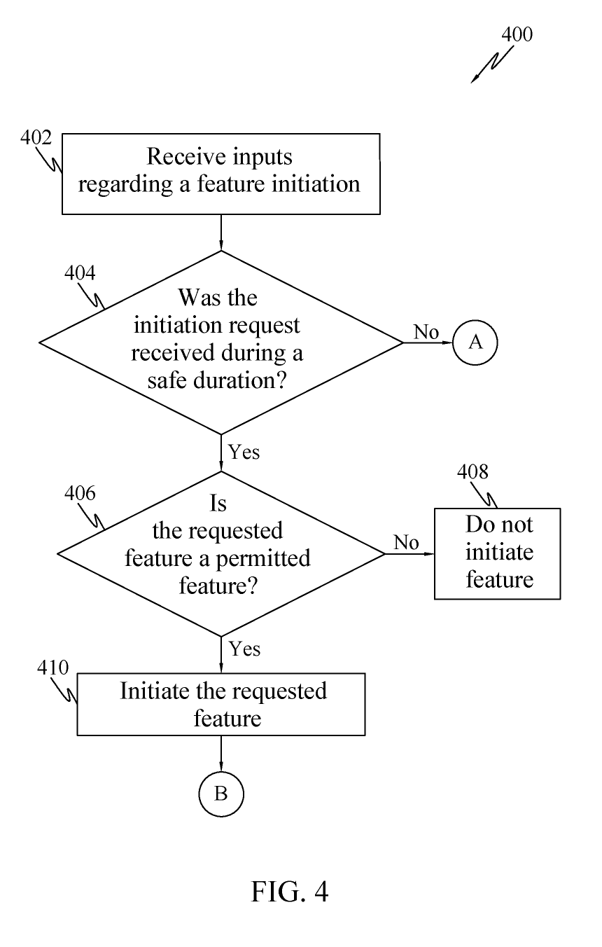

FIG. 4 illustrates a flowchart of an exemplary method for the automobile safety system 102, in accordance with an embodiment;

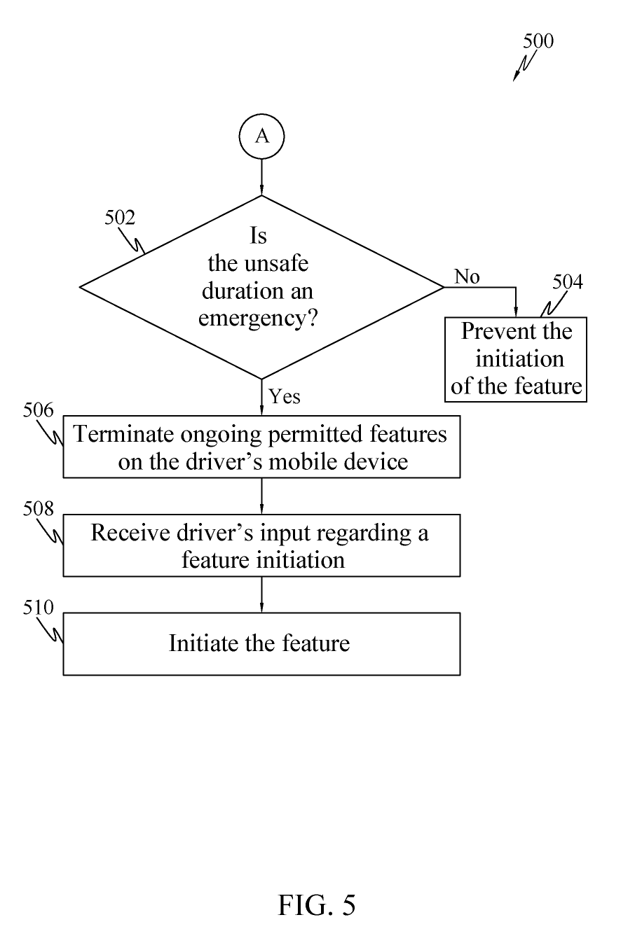

FIG. 5 illustrates a flowchart of an exemplary method for the automobile safety system 102 in case of an emergency, in accordance with an embodiment;

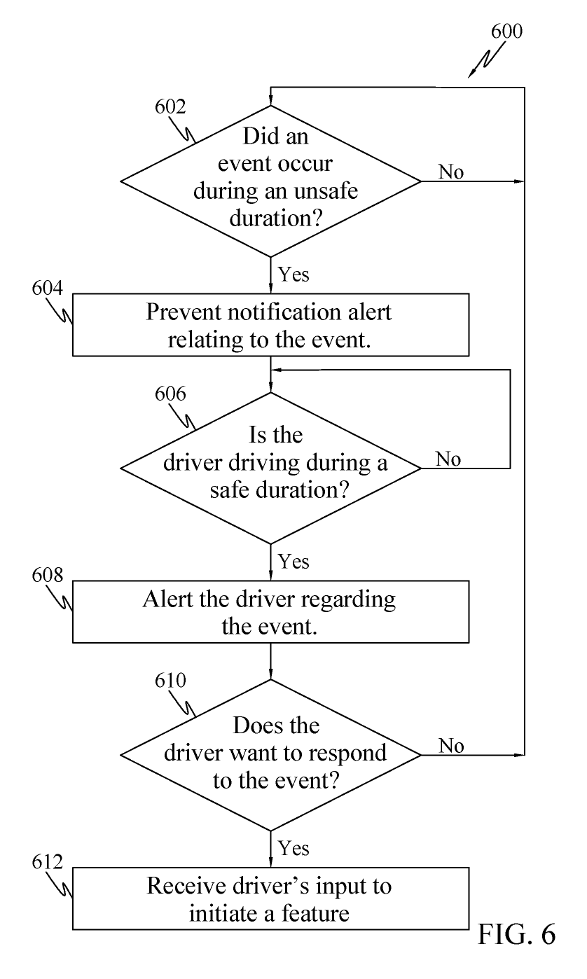

FIG. 6 illustrates a flowchart of an exemplary method for the automobile safety system 102 in case the driver is driving an automobile during an unsafe duration, in accordance with an embodiment;

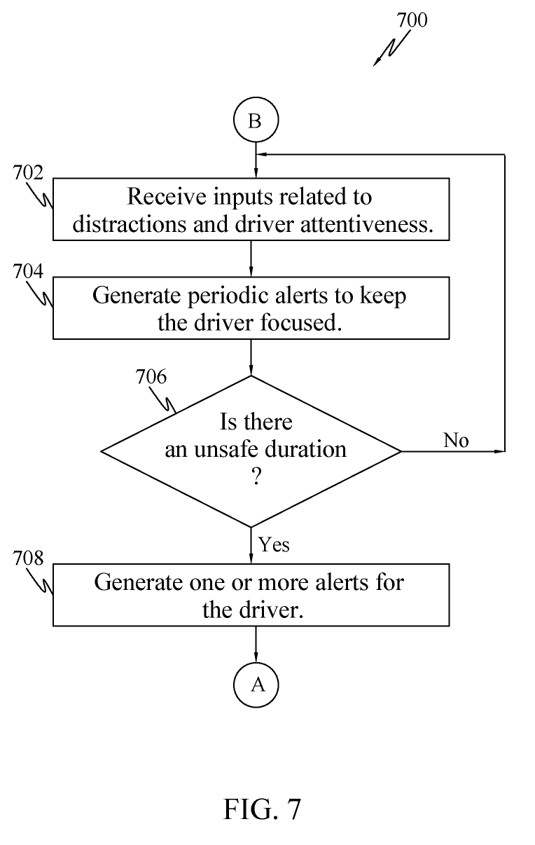

FIG. 7 illustrates a flowchart of an exemplary method for generating alerts for the driver, in accordance with an embodiment;

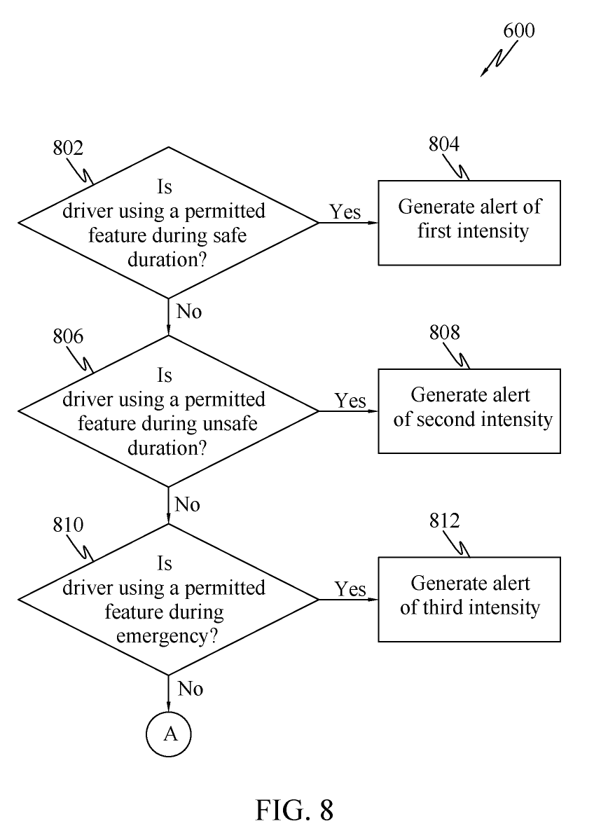

FIG. 8 illustrates a flowchart of an exemplary method for generating alerts for the driver, in accordance with an embodiment; and

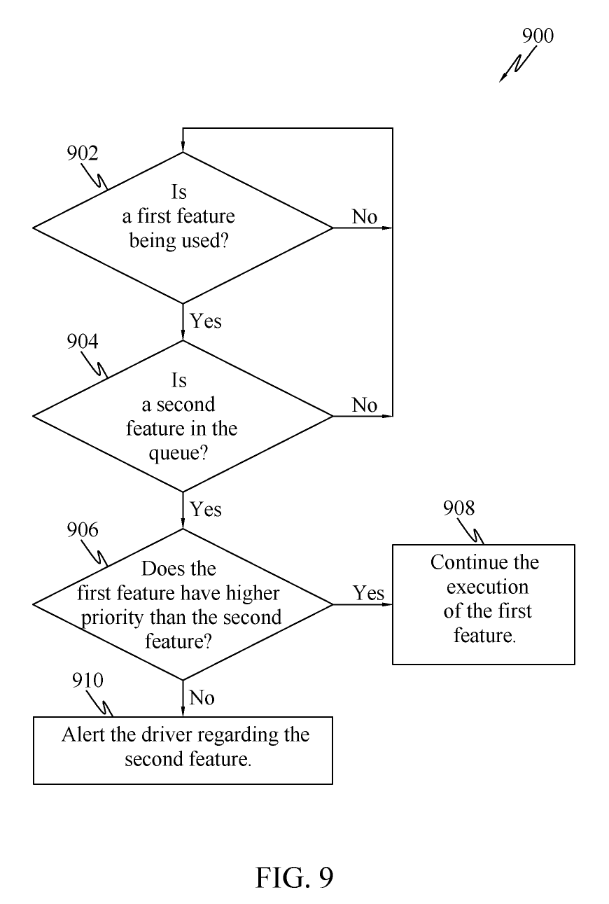

FIG. 9 illustrates a flowchart of an exemplary method for running multiple features for the driver, in accordance with an embodiment.

### DETAILED DESCRIPTION OF THE INVENTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

It should be understood that the capabilities of the invention described in the present disclosure and elements shown in the figures may be implemented in various forms of hardware, firmware, software, non-transitory computer readable medium or combinations thereof.

### Overview

The embodiments disclose an automobile safety system which can be installed on a mobile device of the driver. The automobile safety system allows the driver to use selected features on their driver's mobile device while they are driving, without requiring to physically handle the phone. The automobile safety system receives instructions from the driver in the form of sound, image and/or video. This input is processed and interpreted by the automobile safety system. Further, the automobile safety system receives inputs related to the driver's attentiveness and objects on the road, among others. The automobile safety system processes these inputs to check whether the driver is driving during a safe duration or an unsafe duration. In case the driver is driving during a safe duration, the automobile safety system allows the driver to initiate some features on the driver's mobile device. In case the driver is driving in an unsafe duration, the automobile safety system prevents the driver from using features on their driver's mobile device.

### Automobile Safety System 102

FIG. 1 illustrates a system 100 including an automobile safety system 102 and a driver's mobile device 104 comprising a safety application 106, in accordance with an embodiment. The automobile safety system 102 may be placed inside an automobile driven by the driver in order to receive one or more inputs of the driver. The driver may place the driver's mobile device 104 inside the automobile as depicted.

In an embodiment, the automobile safety system 102 may be similar to the automobile safety system 102 as described in Indian application no. 201641028678. The automobile safety system 102 may comprise a first and a second camera. The first camera may be directed to have a field of view to capture one or more images and/or videos of a driver in the automobile. The second camera may be directed to have a field of view to capture one or more images and/or videos of a road ahead of the automobile. The automobile safety system 102 may further include one or more speakers through which an alert may be generated for the driver. The automobile safety system 102 may further comprise a processing module configured to communicate one or more data with a safety application 106 on the driver's mobile device 104. This data may include one or more of driver information, instructions, driver inputs and camera inputs, among others.

In an embodiment, the automobile safety system 102 may establish a connection with the driver's mobile device when the driver enters the automobile. Further, the automobile safety system 102 may receive one or more notifications and inputs from the driver to initiate one or more features on the driver's mobile device 104. The automobile safety system 102 may determine whether the driving conditions are safe or unsafe based on, for example, inputs from the first camera and the second camera. In case the automobile is being driven in safe conditions, then one may presume that automobile is being driven in a safe duration. On the other hand, if the automobile is being driven in unsafe conditions, then one may presume that automobile is being driven in an unsafe duration. Further, the automobile safety system 102 may enable the initiation of one or more permitted features on the driver's mobile device 104 in case a safe duration has been determined. The automobile safety system 102 may prevent the initiation of one or more of the one or more permitted features on the driver's mobile device 104 in case an unsafe duration has been detected. Further, the automobile safety system 102 may alert the driver during an unsafe duration regarding one or more possible distractions and during a safe duration regarding one or more among an alert to keep the driver focused and one or more received notifications.

In an embodiment, the functionality of the automobile safety system 102 may be carried out by the safety application 106. In this case, one or more inputs from the driver, the first camera and the second camera, among others, may be received by the safety application 106.

The automobile safety system 102 may allow the driver to perform one or more actions on the driver's mobile device 104 while the driver is driving, without the driver physically picking up the driver's mobile device 104. The one or more actions may include: initiating one or more features, allowing a co-passenger to use the driver's mobile device 104 and choosing different user profiles, among others.

In an embodiment, the driver may initiate one or more features in the driver's mobile device 104 by using the automobile safety system 102. The actions may include one or more of answering an incoming call, making a call, sending and receiving text messages, using navigation, using and controlling music, setting alarms and reminders, among others.

In an embodiment, the automobile safety system 102 may be configured to receive one or more inputs to initiate a feature in the driver's mobile device 104. The input may be received from the driver or passenger, or from the mobile device 104 (ex: receiving a call, message and notifications from apps). Further, the automobile safety system 102 may determine from one or more inputs whether the driver is driving an automobile during a safe duration or an unsafe duration and whether the requested feature belongs to a group of one or more permitted features. The automobile safety system 102 may prevent the initiation of the feature in case the feature does not belong to the group of one or more permitted features. The automobile safety system 102 may initiate the feature in case the input to initiate is received in the safe duration and the feature does not belong to the group of one or more permitted features. Further, the automobile safety system 102 may refrain from initiating the one or more features in case the input to initiate is received in the unsafe duration.

In an embodiment, the automobile safety system 102 may receive and interpret one or more inputs corresponding to the driver, a co-passenger or the automobile safety system 102, among others. Further, the inputs may include one or more of a voice input, gesture input, image input or video input. Voice or verbal inputs from the driver or co-passenger may be received by the microphone of the automobile safety system 102. Further, one or more body gesture inputs, image inputs and video inputs may be recorded by a recording mechanism such as a camera, for example, the first camera of the automobile safety system 102.

FIG. 2 illustrates an exemplary block diagram of a driver's mobile device 104 of the system 100, in accordance with an embodiment. The driver's mobile device 104 may include a processing module 202, a memory module 204, an input/output module 206, a display module 208, a communication interface 210, an application module 214, and a bus 212 connecting all the modules of the driver's mobile device 104.

In an embodiment, the processing module 202 of the driver's mobile device 104 may communicate with the may be used to determine situations wherein the driver needs to be alerted in case of a potentially harmful situation such as an unsafe duration or an emergency. The processing module 202 may be implemented in the form of one or more processors and may be implemented as appropriate in hardware, computer-executable instructions, firmware, or combinations thereof. Computer-executable instruction or firmware embodiments of the processing module 202 may include computer-executable or machine-executable instructions written in any suitable programming language to perform the various functions described. Further, the processing module 202 may communicate with the other modules of the driver's mobile device 104 through the bus 212.

In an embodiment, the memory module 204 may be implemented in the form of a primary and a secondary memory. The memory module 204 may store additional data and program instructions that are loadable and executable on the processing module 202, as well as data generated during the execution of these programs. Further, the memory module 204 may be a volatile memory, such as random access memory and/or a disk drive, or non-volatile memory. The memory module 204 may comprise of removable memory such as a Compact Flash card, Memory Stick, Smart Media, Multimedia Card, Secure Digital memory, or any other memory storage that exists currently or may exist in the future.

In an embodiment, the input/output module 206 may provide an interface for input devices such as the driver's mobile device 104 and a microphone;

and for output devices such as a speaker and display, among others. In an embodiment, the microphone may be used to receive one or more input from the driver and/or a co-passenger. Further, the speaker may be used to generate one or more alerts and/or notifications for the driver and/or the co-passenger.

In an embodiment, the display module 208 may be configured to display content. The display module 408 may also be used to receive an input from a driver and/or display one or more outputs or information to the driver. The display module 208 may be of any display type known in the art, for example, Liquid Crystal Displays (LCD), Light emitting diode displays (LED), Cathode Ray Tube Displays (CRT), Orthogonal Liquid Crystal Displays (OLCD) or a combination of these or any other type of display currently existing or which may exist in the future. The display module 308 ma0y also be used to alert the driver.

In an embodiment, the communication interface 210 may provide an interface to communicate with the driver's mobile device 104. The communication interface 210 may also enable communication with one or more remote systems.

The communication interface 210 may include an antenna and a communication port, among others and may include devices supporting both wired and wireless protocols. One or more data in the form of electronic, electromagnetic and optical signal, among other signals may be transferred via the communication interface 210. Further, the communication interface 210 may be compatible with different 7technologies including NFC, ultrasound, Bluetooth, WLAN, USB and GPS, among others.

In an embodiment, the application module 214 may be implemented as software. The driver's mobile device 104 may download an installer file that includes at least one application bundled with at least one configuration parameter.

In an embodiment, the application module 214 may further comprise a safety application 106. The safety application 106 may communicate one or more information with the automobile safety system 102. This information may include one or more information related to one or more driver inputs, calls, messages and other notifications received by the driver's mobile device 104.

FIG. 3 illustrates an exemplary block diagram of the safety application 106 of the system 100, in accordance with an embodiment. The safety application 106 may further comprise an input module 300, a processing module 302, a memory module 304 and a decision module 306. The input module 300 may receive one or more inputs from the driver, a network connected to the mobile device, an external source or a passenger. Further, the input module 300 may store one or more information in the memory module 304. The processing module 302 may process one or more inputs and/or outputs. Further, the decision module 306 communicates with the automobile safety system in order to determine when a feature on the driver's mobile device 104 may be initiated and/or executed.

FIG. 4 illustrates a flowchart of an exemplary method for the automobile safety system 102, in accordance with an embodiment. In an embodiment, the automobile safety system 102 may receive inputs from the driver. Further, the inputs may include a feature initiation request from the driver to the automobile safety system 102 to initiate a feature. The automobile safety system 102 may first check whether the driver made this request during a safe duration or an unsafe duration and only allow initiating a feature that was requested during a safe duration.

In an embodiment, the automobile safety system 102 may receive one or more inputs regarding a feature initiation as depicted in step 402. The automobile safety system 102 may determine whether the feature initiation request was received during a safe duration as depicted at step 404. The automobile safety system 102 may proceed to step A of FIG. 5 in case the feature was not initiated in the safe duration. In case the driver tried to initiate the feature in the safe duration, the automobile safety system 102 may determine whether the requested feature belongs to the group of permitted features as depicted at step 406. In case the requested feature does not belong to the group of permitted features, the automobile safety system 102 may not initiate the feature as depicted at step 408. In case the requested feature belongs to the group of permitted features, the automobile safety system 102 may initiate the feature as depicted at step 410. Further, the automobile safety system 102 may proceed to step B of FIG. 7.

In an embodiment, as an example, the driver's mobile device 104 may receive a voice call during a safe duration from a person who wishes to contact the driver. Further, the automobile safety system 102 in the driver's mobile device 104 determines that the voice call was received during a safe duration. Subsequently, the automobile safety system 102 may determine that the voice call belongs to the group of permitted features, and may initiate the voice call by sounding a voice notification and/or a ring tone through the speakers on the automobile safety system 102. For example, the automobile safety system 102 may give an output such as: “You are receiving a call from Neil. Do you want to pick up the call?”. Subsequently, the safety application 106 may receive and interpret the reply of the driver.

FIG. 5 illustrates a flowchart of an exemplary method for the safety application 106 in case of an emergency, in accordance with an embodiment. The automobile safety system 102 may process one or more received inputs to determine whether the unsafe duration is an emergency as shown at step 502. These inputs may include inputs from the driver, a co-passenger or one or more cameras included in the automobile safety system 102, among others. In case the unsafe duration is not an emergency, the safety application 106 may prevent the initiation of the feature, as depicted at step 504. In case the unsafe duration was determined to be an emergency, the safety application 106 may terminate one or more ongoing permitted features on the driver's mobile device 104, as depicted at step 506. Further, the safety application 106 may receive one or more inputs from the driver regarding the initiation of a feature, as depicted at step 508. The driver may be allowed to initiate any feature in the driver's mobile device 104 during the emergency as required, as shown at step 510.

In an embodiment, as an example, a driver may be dictating a text message when an emergency such as an accident occurs. In this case, the automobile safety system 102 may determine that there is an emergency and may terminate the text message feature. Further, the automobile safety system 102 may ask the driver whether he wants to initiate any feature by giving an output through the speakers such as: “Alert. This is an emergency. What do you want to do?”. The driver may reply by instructing the automobile safety system 102 to call a family member or an ambulance. The automobile safety system 102 may then proceed to initiate the calls requested by the driver.

FIG. 6 illustrates a flowchart of an exemplary method for the automobile safety system 102 in case the driver is driving an automobile during an unsafe duration, in accordance with an embodiment. The automobile safety system 102 may determine whether an event occurred during an unsafe duration as depicted at step 602. An alert, in some embodiments, may be as good as an input to initiate a feature. Further, the automobile safety system 102 may be configured to prevent one or more notification alerts regarding the event in case the event occurred during the unsafe duration, as depicted at step 604. In case the event did not occur during the unsafe duration, the automobile safety system 102 may monitor further events.

The automobile safety system 102 may determine whether the driver is now driving in a safe duration, as depicted at step 606. At step 608, the automobile safety system 102 may alert and notify the driver in the safe duration regarding the event that occurred during the unsafe duration. Further, the automobile safety system 102 may determine whether the driver wants to respond to the event by initiating one or more permitted features during the safe duration, as depicted at step 610. Subsequently, the automobile safety system 102 may receive and use the driver's inputs to initiate the one or more permitted features chosen by the driver.

In an embodiment, as an example, the automobile safety system 102 may determine that the driver is driving during an unsafe duration. In case an event such as a text message is sent to the driver's mobile device 104, the automobile safety system 102 prevents the generation of a notification alert for the text message. Further, the safety application 106 may wait until the driver is driving during a safe duration to alert and notify the driver regarding the event. The automobile safety system 102 may send an output through the speakers such as: “You have received a text message while you were driving. Do you want to hear it?” Further, the safety application 106 may receive the driver's input to initiate a feature in response to the occurred event.

FIG. 7 illustrates a flowchart of an exemplary method for generating alerts for the driver, in accordance with an embodiment. The automobile safety system 102 may receive one or more inputs related to the attentiveness of the driver and one or more distractions, as depicted at step 702. Further, the automobile safety system 102 may generate one or more alerts (e.g. pre-configured and/or periodic alerts) to keep the driver focused while driving, as depicted at step 704, in case the driver is using a permitted feature in the safe duration. The automobile safety system 102 may determine whether there is an unsafe duration while the driver is driving their automobile, as depicted at step 706. Subsequently, at step 708, the automobile safety system 102 may generate one or more alerts in case the automobile safety system 102 determines that the driver is in an unsafe duration based on the one or more inputs.

In an embodiment, as an example, the automobile safety system 102 may have initiated a voice call for the driver while they are driving during the safe duration. Further, the automobile safety system 102 may generate one or more light, audio or vibratory alerts in the form of sounds or lights at periodic intervals. These alerts may remind the driver to stay focussed while they are simultaneously driving and talking on the voice call. Further, in case the automobile safety system 102 determines that the driver in now driving during an unsafe duration, the automobile safety system 102 may generate one or more different alerts to signify to the driver that they are driving in an unsafe duration and thus, need to stay focussed on driving.

FIG. 8 illustrates a flowchart of an exemplary method for generating alerts for the driver, in accordance with an embodiment. In an embodiment, the automobile safety system 102 may determine whether the driver is using a permitted feature during a current safe duration, as depicted at step 802. Further, at step 804, the safety application 106 may generate an alert of a first intensity level in case the driver is using a permitted feature in the safe duration. Subsequently, the automobile safety system 102 may determine whether the driver is using a permitted feature during a current unsafe duration, as depicted at step 806. Further, at step 808, the automobile safety system 102 may generate an alert of a second intensity level in case the driver is using a permitted feature in the unsafe duration.

The automobile safety system 102 may determine whether the driver is using a permitted feature during a current emergency, as depicted at step 810. Further, at step 812, the automobile safety system 102 may generate an alert of a third intensity level in case the driver is using a permitted feature in the emergency.

In an embodiment, the third intensity level may be greater compared to the second intensity level and the second intensity level may be greater compared to the first intensity level. The higher-level intensity alerts may comprise a sound alert of an increased volume and/or light and vibratory alerts.

In an embodiment, as an example, the driver may be having a discussion over a voice call. During the safe duration, the automobile safety system 102 may generate a twinkling light alert. Further, during the unsafe duration, the automobile safety system 102 may generate a twinkling light alert and vibratory. Subsequently, during an emergency, the automobile safety system 102 may generate a loud sound alert and a bright light alert.

In an embodiment, the automobile safety system 102 may list one or more permitted features of the group of one or more permitted features, into a priority list. A permitted feature having higher priority may be initiated before a permitted feature with lower priority. In case a permitted feature is already in use, it may be replaced by a subsequent permitted feature only if the subsequent permitted feature has a higher priority than the initial permitted feature. This ensures that the driver receives important notifications before non-important notifications. Further, it helps the driver to save time spent on going through all notifications while searching for important notifications. As an example, in case the driver has simultaneously received an e-mail from work, an advertisement text message, and a voice call from home, the automobile safety system 102 may first execute the voice call. The voice call may have higher priority than the work e-mail, which has higher priority than the advertisement text message. Once the driver has finished talking, the automobile safety system 102 may alert the driver regarding the e-mail from work. Subsequently, the driver may be alerted regarding the advertisement text message.

FIG. 9 illustrates a flowchart of an exemplary method for running multiple features for the driver, in accordance with an embodiment. This flowchart describes the steps taken by the automobile safety system 102 in case a new feature must be initiated while a feature is currently being executed. As depicted at step 902, the automobile safety system 102 may monitor whether a first feature is being used by the driver on their driver's mobile device 104. In case a first feature is being used, the automobile safety system 102 may monitor whether a second feature is in the queue for initiation, as depicted at step 904. Further, at step 906, in case there is a second feature in the queue waiting to be executed, the automobile safety system 102 may determine whether the first feature has a higher priority than the second feature. In case the first feature has higher priority than the second feature, the automobile safety system 102 may continue the execution of the first feature, as depicted at step 908. In case the first feature has higher priority than the second feature, the automobile safety system 102 may alert the driver regarding the second feature, by generating a notification for the driver, as depicted at step 910.

In an embodiment, the second feature may be initiated by one or more of the driver, a co-passenger, the driver's mobile device 104 or an external source. The external source may be one or more of a person, an application, a website or an organization.

In an embodiment, the automobile safety system 102 may interpret one or more pre-determined inputs of the driver to allow the driver or a co-passenger to allow the initiation of at least one feature in a group of one or more features on the driver's mobile device 104 in a safe duration and an unsafe duration. In an embodiment, the automobile safety system 102 may be configured to process a pre-determined over-ride command. This over-ride command may be received as an input from the driver or the co-passenger. In case the safety application 106 receives the over-ride command, the automobile safety system 102 may interpret it and allow the driver or co-passenger to initiate one or more among features on the driver's mobile device 104 including the group of one or more permitted features. Further, the automobile safety system 102 may continue to initiate one or more features requested by the driver, without determining whether the present duration is the safe duration or the unsafe duration.

In an embodiment, the group of one or more features may comprise one or more features that the driver can not initiate during a drive. For example, one or more features such as viewing videos, pictures and playing games may not be allowed during any duration in order to prevent the driver from being distracted while driving.

In an embodiment, the group of features may be similar to a universal group that may include one or more features that are not present in the group of one or more permitted features. The driver may use one or more pre-determined inputs such as a password or a passcode to override the automobile safety system 102 in order to allow the driver to access one or more features that are not permitted before the automobile safety system 102 has been over-ridden. Hence, there may be a group of one or more features, of which some features may be inaccessible by the driver before they enter a password to override the automobile safety system 102.

In an embodiment, the group of one or more features are pre-determined by the driver. This allows the driver to determine which features may be accessed by the co-passenger to maintain security and protect the privacy of the driver regarding their driver's mobile device 104. For example, the driver may choose to exclude their e-mail account or picture gallery in the group of one or more features that may be accessed by a co-passenger. This may prevent theft of confidential information related to the driver.

### Conclusion

The forgoing disclosure overcomes the drawbacks of the conventional safety applications, by determining a safe duration wherein the driver may use some functionality on their driver's mobile device. Further, the safety application prevents the mobile device from distracting the driver during an unsafe duration. Further, the system alerts the driver when they are using a feature on their mobile device in order to help them keep their focus while driving. Also, different alerts may be generated when there is a potential distraction while driving the automobile. Thus, the present invention as discussed in this document with respect to different embodiments will be advantageous at least in providing additional protection for a driver. Further, it is advantageous in providing better safety and decreasing the chances of accidents and collisions. It is also advantageous in helping the driver to keep track of notifications received on their user's mobile device, without getting distracted during potentially unsafe durations. Furthermore, the system is also advantageous in decreasing accident rates. Additional advantages not listed may be understood by a person ordinary skilled in the art in view of the embodiments disclosed above.

In the foregoing detailed description, numerous specific details, examples, and scenarios are explained in order to facilitate a thorough understanding of the present disclosure. However, the embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation. Thus, the scope of the invention should be determined by the appended claims and their legal equivalents rather than by details, examples, and scenarios provided.

It shall be noted that the processes described above are described as sequence of steps; this was done solely for the sake of illustration. Accordingly, it is understood that some steps may be added, some steps may be omitted, the order of the steps may be re-arranged, or some steps may be performed simultaneously.

Although embodiments have been described with reference to specific example embodiments, it will be evident that various combinations, modifications, additions, and omissions may be made to these embodiments without departing from the broader spirit and scope of the foregoing disclosure and appended claims. Accordingly, the specification and drawings are to be regarded in an illustrative sense rather than a restrictive sense. It is to be understood that the phraseology or terminology employed herein is for description and not of limitation.

I claim:

1. An automobile safety system (102) configured to work with a driver's mobile device (104), the automobile safety system (102) being configured to:
receive one or more inputs to initiate a feature in the driver's mobile device (104);
determine whether the driver is driving an automobile during a safe duration or an unsafe duration;
determine whether the feature requested belongs to a group of one or more permitted features;
prevent the initiation of the feature in case the feature does not belong to the group of one or more permitted features;
initiate the feature in case the input to initiate is received in the safe duration and the feature belongs to the group of one or more permitted features; and
refrain from initiating the one or more features in case the input to initiate is received in the unsafe duration.

2. The automobile safety system (102) according to claim 1, wherein the automobile safety system (102) is configured to receive and interpret the one or more inputs corresponding to the driver, wherein the one or more inputs are in the form of at least one of a voice input, gesture input, image input or video input.

3. The automobile safety system (102) according to claim 1, wherein the automobile safety system (102) is further configured to:
prevent one or more notification alerts regarding an event in case the event occurs during the unsafe duration; and
alert and notify the driver in the safe duration regarding the event that occurred during the unsafe duration.

4. The automobile safety system (102) according to claim 3, wherein the automobile safety system (102) is further configured to:
determine whether the driver wants to initiate one or more permitted features during the safe duration, wherein the one or more permitted features are in response to the occurred event; and
receive and use the driver's inputs in case the driver wants to initiate the one or more permitted features.

5. The automobile safety system (102) according to claim 1, wherein the automobile safety system (102) is further configured to:
receive one or more inputs related to the attentiveness of the driver and one or more distractions;
generate one or more periodic alerts to keep the driver focussed while driving in case the driver is using a permitted feature in the safe duration; and
generate one or more alerts in case the automobile safety system (102) determines that the driver is in unsafe duration based on the one or more inputs.

6. The automobile safety system (102) according to claim 5, wherein the automobile safety system (102) is further configured to:
determine whether the unsafe duration comprises an emergency;
terminate one or more ongoing permitted features on the driver's mobile device (104); and
receive input from the driver to initiate one or more of the one or more features on the driver's mobile device (104) in case of an emergency.

7. The automobile safety system (102) according to claim 6, wherein the automobile safety system (102) is further configured to:
generate an alert of a first intensity level in case the driver is using a permitted feature in the safe duration;
generate an alert of a second intensity level in case the driver is using a permitted feature in the unsafe duration; and
generate an alert of a third intensity level in case the driver is using a permitted feature in the emergency; wherein the third intensity level is greater compared to the second intensity level and the second intensity level is greater compared to the first intensity level.

8. The automobile safety system (102) according to claim 1, wherein the automobile safety system (102) is further configured to list one or more permitted features belonging to the group of one or more permitted features in a priority list, wherein a permitted feature having higher priority is initiated before a permitted feature with lower priority.

9. The automobile safety system (102) according to claim 1, wherein the automobile safety system (102) is further configured to interpret one or more pre-determined inputs of the driver to allow initiation of at least one feature in a group of one or more features on the driver's mobile device (104) in the safe duration and the unsafe duration.

10. The automobile safety system (102) according to claim 9, wherein the group of one or more features comprise one or more features that are restricted from initiation by the driver prior to the interpretation of the one or more pre-determined inputs of the driver.

11. The automobile safety system (102) according to claim 9, wherein the group of one or more features are configurable to be pre-determined by the driver, when the driver wants to restrict the co-passenger from accessing one or more features.

12. An automobile safety system (102) configured to work with a driver's mobile device (104), the automobile safety system (102) comprising:
a first camera directed to have a field of view to capture video of a driver of the automobile;
a second camera directed to have a field of view to capture video of a road ahead of the automobile; and
a processing module configured to:
communicate with a driver's mobile device (104);
receive one or more notifications from the driver's mobile device (104);
receive one or more inputs from the driver to initiate one or more features on the driver's mobile device (104);
determine a safe duration and an unsafe duration based on inputs from the first camera and the second camera;
enable initiation of one or more permitted features on the driver's mobile device (104) in case the safe duration has been detected;
prevent the initiation of one or more of the one or more permitted features on the driver's mobile device (104) in case the unsafe duration has been detected;
alert the driver during the unsafe duration regarding one or more possible distractions; and
alert the driver during the safe duration regarding one or more among an alert to keep the driver focused and one or more received notifications.
